(19) United States
(12) Patent Application Publication
(10) Pub. No.: US 2008/0057132 A1
(43) Pub. Date: Mar. 6, 2008

(54) "GOT CHA"

(75) Inventor: Rafael Ralph Pagan, Whitestone, NY (US)

Correspondence Address: Rafael Ralph Pagan, 146 - 28 24Th Avenue, Whitestone, NY, 11357, US

(73) Assignee: LORD CASTLE TREE, Whitestone, NY (US)

(21) Appl. No.: 11/772,094

(22) Filed: Jun. 29, 2007

(51) Int. Cl. A01N 65/00; A01N 63/00; A01P 17/00

(52) U.S. Cl. 424/523; 424/522; 424/535; 424/725; 424/727; 424/747; 424/757; 424/776

(57) ABSTRACT

My invention “GOT CHA”, unique and different, invites the world to practice ecological awareness. It's the ultimate alternative embodiment eliminating toxicity at manufacturing levels of business. This product is world user friendly to all areas of industries that require exterminating insects whether they are crawling or flying, “GOT CHA” gets the job done safely and instantly.

### BACKGROUND OF INVENTION

I, Rafael, Ralph, Pagan duly swear that my “GOT CHA” was invented by me to help our worlds ecosystem and provide a safer way for exterminating insects in the insect exterminating industry. My method, and purpose for my invention is to create a safer functioning method and safer product that is allowable and useful in the presence of people, animals, guests, before business meetings, before opening of stores or fast food restaurants and for those interested in the health and well being of the planet and ecological systems such as water streams, rivers, creeks, oceans, and cows who may eat dangerous grass. People who may eat otherwise dangerous fruits sprayed with harmful pesticides and insecticides would not have to be concerned with lethal DDT or toxic sprays. I also created my invention “GOT CHA” with non combustible, non flammable, non lethal toxic chemicals, and created its method to be used in containers that recyclable, using no aerosol pressurized cans that pose a danger to its users. The contents of my “GOT CHA” are recyclable, sewer treatable, biodegradable, pose no dangers to smokers or non smokers, and can safely be disposed in recyclable garbage.

My method for using my “GOT CHA” is also a method in which this product has never been used in any industry for the extermination of insects by use of a liquid in a spray bottle that is non toxic, non combustible and safe to recycle. It is safe to people, the outdoor and indoor environments. My safe liquid is a method in which has not been for sale or marketed in the pesticide or insecticide industry or market. My method of manufacturing, bottling, and using my invention is unique and my very own idea and creation.

### BREIF DESCRIPTION OF DRAWINGS

The object and features of the invention are illustrated so that a reference to the detailed description may be adjoined for better understanding in which

FIG. 1 is a side view of a glass jar filled with 8 ounces of water;

FIG. 2 is a side view of a jar containing 3 ounces of Potassium Hydroxide that is carefully measured by the use of an affixed object drawn beneath it to represent a weight measuring scale;

FIG. 3 is a side view of a graduated thermal heat resistant glass jar that contains the 3 ounces of Potassium Hydroxide that is added to the 8 ounces of water in FIG. 1 and a thermometer is affixed to the drawing in a side view to indicate that a temperature of 140 degrees Fahrenheit must be reached in the mixture;

FIG. 4 is a side view of a graduated thermal heat resistant glass jar containing the mixture of 8 ounces of water and 3 ounces of Potassium Hydroxide at 140 degrees Fahrenheit affixed with a side view of a temperature reading thermometer;

FIG. 5 a transparent side view of a stainless steel pot filled with oil extract or any oils or fats situated on top of a energy producing appliance that heats the oils or fats to a temperature not to exceed 160 degrees Fahrenheit mixed with the contents from FIG. 4 and affixed is a side view of an industrial oil thermometer to illustrate a need for careful temperature monitoring;

FIG. 6 a back view of FIG. 5 illustrating that the mixtures have been blended heated and mixed to form a new physical, changed chemical, possessing a new embodiment specifically created and invented for the purpose of a people friendly and environmentally safe pesticide and insecticide that a ½ ounce of citric acid and ½ ounce of sodium chloride was later mixed into the new and finished product to further demonstrate its natural and ecologically friendly contents and ingredients

### DETAILED DESCRIPTION OF INVENTION

In my contemplation the best mode for describing the Description of The Preferred Embodiment of my invention “GOT CHA” is to make claim that my “GOT CHA” is intentionally created by me, Rafael Ralph, Pagan in liquid form to improve upon the practices of manufacturing pesticides and insecticides, and the uses of pesticides and insecticides by introducing my “GOT CHA” invention as a new preferred embodiment of an insect killing bug spray that allows for an economically cheaper method of producing “GOT CHA”, a non flammable, non combustible insect killing bug spray that has been tested to wipe out flying, crawling insects and their colonies. I invented “GOT CHA” to be as a safe transferable liquid that can be exchanged or poured from one container to another without concerns of spillage or making contact with the skin, clothing, furniture or surfaces. “GOT CHA” is ecologically safe to mammals, water streams, underground aquifers, oceans and rivers. It proves to be a bug spraying product that exterminates insects, but provides no threat to the Ozone layer of our atmosphere or danger to our air quality and general environment. Unlike the common toxic aerosol bug killing sprays already saturating our markets, my invention, due to its ingredients, I have chosen, is biodegradable, promotes a safer method and healthier awareness attitude in those using it for what would other wise be considered unsafe, unhealthy, dangerous and even lethal. The procedure for manufacturing or producing “GOT CHA” begins as follows:

I, Rafael, Ralph, Pagan, began the creation of my invention “GOT CHA” by gathering all of my chosen ingredients:

I added 3 ounces of Potassium Hydroxide to 8 ounces of water.

Upon adding the Potassium Hydroxide to the water in a thermal heat resistant graduated pitcher, I slowly stirred the mixture until its temperature reached 140 degrees Fahrenheit. In the pitcher I affixed a thermometer to assure an accurate reading of 140 degrees.

Using 16 ounces of Olive extract, I poured the Olive extract into a boiler pot to reach a boiling point of 160 degrees Fahrenheit. The Olive extract temperature is measured with an industrial cooking thermometer. At the precise timing of each Potassium Hydroxide and Olive extract reaching their temperatures of 140 degrees Fahrenheit and 160 degrees Fahrenheit

I carefully poured, added, the Potassium Hydroxide and water mixture into the pot of Olive extracts and began vigorously stirring to blend each of the separate properties together in a pot over a flame. I added heat energy to the blending or mixing ingredients not to exceed or bring the ingredient temperatures to reach over 160 degrees Fahrenheit.

Assuring that while the two mixtures were heating at 160 degrees and never exceeding 160 degrees Fahrenheit I stirred and blended the two ingredients until they formed my new invention for my new and intended revolutionary purpose of creating a world safe and people friendly pesticide and insecticide “GOT CHA”.

My start time was 3:15 pm on Apr. 7, 2007 Saturday afternoon and my product “GOT CHA” began to form into my intended creation and began to have its own new true state and formed into my intended new and different chemical property state and existence which was “GOT CHA”. Then my “GOT CHA”, I created, was ready for the half ounce of citric acid and a half ounce of sodium chloride, I added, to establish my finished creation and product I namely call “GOT CHA.”

### SPECIFICATION DATA

At 8:15 pm, Apr. 7, 2007, I, Rafael, Ralph, Pagan, began the creation of my invention “GOT CHA” by gathering all of my chosen ingredients also describe in my “DRAWINGS” section of the SPECIFICATION DATA SHEET and blending them together under heat to make “GOT CHA”.

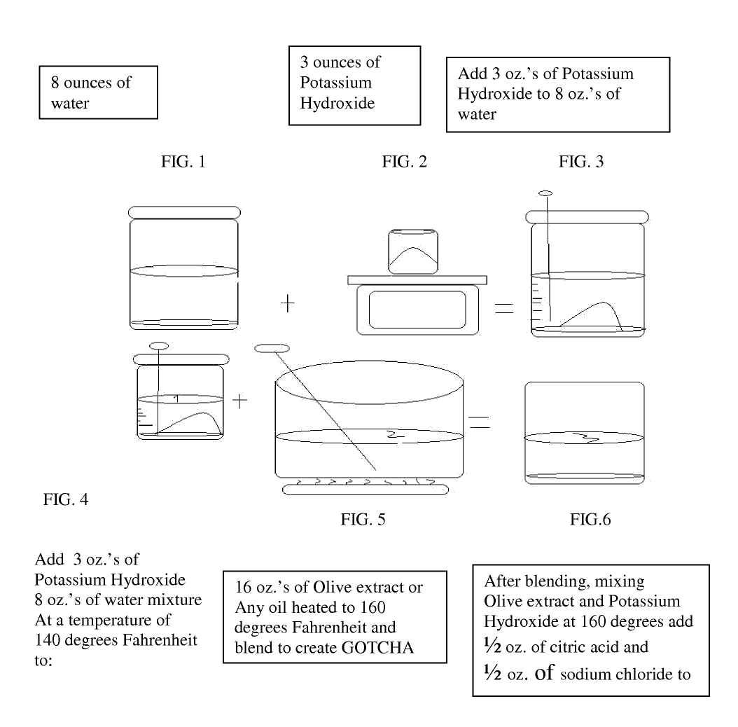

I added 3 ounces of Potassium Hydroxide to 8 ounces of water. (FIG. 1)

Upon adding the Potassium Hydroxide to the water in a thermal heat resistant graduated pitcher, I slowly stirred the mixture until its temperature reached 140 degrees (FIG. 2) Fahrenheit. In the pitcher I affixed a thermometer to assure an accurate reading of 140 degrees.

Using 16 ounces of Olive extract, I poured the Olive extract into a boiler to reach a boiling point of 160 degrees Fahrenheit. At the precise timing of each Potassium Hydroxide and Olive extract reaching their temperatures of 140 degrees Fahrenheit and 160 degrees Fahrenheit. (FIG. 3)

I carefully poured, added, the Potassium Hydroxide and water mixture into the Olive extract and began vigorously stirring to blend each of the separate properties together in a pot over a flame. I added heat energy to the blending or mixing ingredients not to exceed or bring the ingredient temperatures to reach over 160 degrees Fahrenheit. (FIG. 4)

Assuring that while the two mixtures were heating at 160 degrees and never exceeding 160 degrees Fahrenheit I stirred and blended the two ingredients until they formed my new invention for my new and intended revolutionary purpose of creating a world safe and people friendly pesticide and insecticide “GOT CHA”. (FIG. 5)

My start time was 3:15 pm on Apr. 7, 2007 Saturday afternoon and my product “GOT CHA” began to form into my intended creation and began to have its own new and true state and into my intended new and different chemical property state and existence. Then my “GOT CHA”, I created, was ready for the half ounce of citric acid and a half ounce of sodium chloride, I added, to establish my finished creation and product I namely call “GOT CHA.” I created my invention for the purpose of exterminating insects of all kinds and to provide the world with a safer more healthier and more economical insect pesticide and insecticide. My method for using my “GOT CHA” is also a method in which this product has never been used to the best of my knowledge in any industry for the extermination of insects by use of a biodegradable, people safe and environmentally friendly liquid in a spray bottle that is non toxic, safe to people, and safe to the outdoor and indoor environments.

My formulation of the “GOT CHA” is a method that can be packaged in a simple trigger action recyclable pump bottle. This feature combined with its ability to break down in a short period would not provide threat to the ecosystem making it far more environmentally friendly. My method of manufacturing, bottling, and using my invention is unique and my very own idea and creation.

The method of “GOT CHA” is also different and marketable because my GOT CHA is safe enough to use around pets, family members and quests. GOT CHA is safe to use while people are eating at home or during the busiest hours in a restaurant. My method, and purpose for my invention is to create a safer functioning method and safer product that is allowable and useful in the presence of people, animals, guests, before business meetings, before opening of stores or fast food restaurants and for those interested in the health and well being of the planet and ecological systems such as water streams, rivers, creeks, oceans, and cows that may eat dangerous grass. People who may eat otherwise dangerous fruits sprayed with harmful pesticides and insecticides would not have to be concerned with lethal DDT or toxic sprays. I also created my invention “GOT CHA” with non combustible, non flammable, non lethal toxic chemicals, and created its method to be used in containers that recyclable, using no aerosol pressurized cans that pose a danger to its users. The contents of my “GOT CHA” are recyclable, sewer treatable, biodegradable, pose no dangers to smokers or non smokers, can be used on open flames and near campfires and can safely be disposed in recyclable garbage.

### SUMMARY OF INVENTION

My invention of my “GOT CHA” bug spray is created by me, Ralph Rafael, Pagan, to revolutionize and change the methods and uses of already existing insecticides and pesticides through out the world. Generally pesticides and insecticides are: Flammable, combustible under pressure, toxic to ingesting, toxic to inhalation, dangerous to children, harmful to eyes, dangerous to humans in general, harmful and dangerous to the environment, dangerous and harmful to sewers and water supplies, proves dangerous if large quantities spill into dirt to underground aquifers. The great scare of the West Nile Virus was not so much the mosquitoes but, the possibility of the effects the air born pesticides and insecticides would have causing irreparable and irreversible damage to the human nervous system. My “GOT CHA”, exterminating bug spray puts the emphasis of accomplishing the mission and satisfaction of ridding pesky bugs. “GOT CHA” is people safe and insect tested!

My insect killing, bug spray, “GOT CHA” is biodegradable, environmentally safe, contains no harmful chemicals, human safe and is the ultimate alternative and replacement to toxicity at the manufacturing levels of business. This product is a world product that is user friendly to all areas of industries that require the extermination of insects of many types whether they are crawling or flying, “GOT CHA” gets the job done safely and instantly. This bug spray can zap wasps and stop them in their tracks, right from mid flight. No more packing up and leaving picnic sites due to colony infestations of any kind. Follow insects back to their nests as all professional exterminators highly recommend and then use my GOOD GOD! “GOT CHA!” and wipe out the entire nest in less than a few sprays. My “GOT CHA” is intentionally created by me, Ralph (Rafael) Pagan in a safe, non toxic liquid form, by claiming that the use of all forms of oils when heated and mixed, or blended with Potassium Hydroxide creates a new method and product in which to exterminate insects so that it is safer to uses in that it is non flammable, non combustible and transferable to one container to another without concerns of spillage or making contact with the skin, clothing, furniture or surfaces. My invention also due to my design for its purpose promotes a healthier method and healthier awareness attitude in those using it for what would other wise be considered an unsafe, unhealthy, dangerous and even lethal. Clean up after spillage would be easy and very cost effective. Unlike conventional insecticides and pesticides “GOT CHA” has safe properties invented to be safe to the touch requiring no toxic clean up or gear. “GOT CHA” is a natural biological control that lowers levels of harm to the environment and abilities of insects to build resistance.

I claim:

1. that I am the original, only creator and sole inventor of the “GOT CHA” insect killing bug spray that provides new methods and new benefits that safely kills insects without, harming the environment or the people or persons who administer, transport, manufacture, or sell, or domestically use it in their homes, businesses, or around open flames such as stoves, camp fires,
a. or matches, as other pesticides or insecticides would,

2. and by utilizing “GOT CHA”, people and the environment are not at risk to toxic fumes nor harmful lingering oil residues or harmful chemicals from said pesticide and insecticide because it is,
a. biodegradable non flammable liquid that is safe to the epidermal layers of the skin, and will not seep into the skin pores, will not pollute or damage ground soil, or under ground aquifers,
b. and is not a toxic aerosol chemical that would other wise, cause damage to the user as other pesticides could, is not a threat to the natural environment, is people friendly and,
c. due to my active use of libraries, the internet and text book knowledge of insect behavior and their biological physical structures I have,
(1) carefully planned, innovatively created and invented the safest, simplest, most economical way of exterminating insects by performing a series of various and different experiments through trial and error methods using my chosen ingredients of fats, palm oils, oils from a large sample group providing a large variety of different oils, such as safflower oils, soybean, vegetable oils sunflower oils, coconut oils, mint seed oils, olive oils, olive extracts, cottonseed oils, corn oils, butter fat, beef fat, lard fat, pork fat, stick margarine, shortening, nut oils, fish oils and avocado extracts or oils then mixing them individually in different experiments with Potassium Hydroxide under temperatures not exceeding 160 degrees Fahrenheit,
(2) inventing and creating a process in which my product, “GOT CHA” utility, which is an environmentally friendly, people safe pesticide and insecticide that is economically inexpensive to produced, safe to manufacture by the use of the majority of all oils whether from plants or seeds or animal fats when blended or mixed with Potassium Hydroxide under temperatures not exceeding 160 degrees Fahrenheit, then mixed with or blended with citric acid, sodium chloride, olive oils, palm oils, in general, animal fats tested on insects to prove to exterminate by using my own test samples of crawling and flying subjects, insects and nesting colonies from the ant farm sites in my backyard, from under my porch, from dead logs, my kitchen cabinets, and from my cool damp basement; moreover, all my experiments, methodologies, engaged and performed showing, proving and providing evidences that my invention and invented process which creates my invention,

3. “GOT CHA”, kills insects and having been recorded and documented, intentionally, further proves and supports that my invented process, is also an invented product or the process formulates and invents a people safe product for killing insects creates,
a. people safe, biodegradable, environmentally friendly bug spray that provides specific people safe and specific environmental safe health factors that justifies the need and reason for inventing, reproducing and manufacturing “GOT CHA” at mass quantities as a world product,
b. and that the method and purpose of manufacturing my invention, promotes safe physical handling of a pesticide, my invention, a safe disposal ability of its liquid existence or its liquid entity, its safe and inexpensive distribution for retail stores, a safe atmosphere and environment for labeling and packaging, a safe embodiment of liquid that produces an ability for nature to break it down and its uses before business meetings, restaurant openings, at picnics, in the kitchens while cooking, uses near or on flames, near smokers and non smokers, indoors and outdoors, for individual insects or for colonies, for its discreetness, and lack of toxic odor, and lack of toxic fumes, to be environmentally safe, people friendly and economically cheaper to mass produce and to sell a killing and exterminating insect product “GOT CHA” that also aides in ridding germs,
c. and is unlike organic pesticides or insecticides that typically use only concentrated spray able oils that either leave sticky oil residue on targeted area that may attract wasps, or create strong emanating smells in its fume vapors that will prove un friendly to people or leave sticky toxic harmful oil residues behind that causes skin irritations,
(1) proving again and again that my invention, method, utility, product, “GOT CHA” does not seep into pores as other organic oil insecticides or oil pesticides do,
(2) does not emit or emanate foul smells that make breathing uncomfortable and does no emit, emanate, spray harmful fumes or does not contain toxic fumes,
(3) does not linger in water, is water soluble, is a safe, non toxic liquid form,

4. by claiming that the use of all forms of oils, animal fats and all types of oils when heated to temperatures not to exceed 160 degrees Fahrenheit and mixed, or blended with Potassium Hydroxide creates,
a. a new method and product in which to exterminate insects with their colonies and invents a safer use of a liquid, invents a safer liquid entity, “GOT CHA”, a non flammable, non combustible, liquid that is easily transferable to one container to another without concerns of spillage or making contact with the skin, clothing, soil, plants or flowers, fruits or vegetables, furniture or surfaces and also due to my invention its purpose promotes a healthier method and healthier awareness attitude in those using it as the clean up after spillage would be so incredibly easy and a very cost effective that,
b. “GOT CHA” being invented, as having safe parts or constituents, that it is safe to the touch, requiring no toxic clean up equipment or gear, has its own natural biological biodegradable control, that will save millions in costs otherwise spent on residual toxic clean-ups and that it lowers the statistical levels of harm to the environment and abilities of insects to build resistance as it is environmentally safe, contains no harmful chemicals, human safe and it provides the ultimate alternative and replacement to toxicity at the manufacturing levels of business as a world product that is user friendly to all areas of industries to all environments that require the extermination of insects of many types whether they are crawling or flying,

5. “GOT CHA” gets the job done safely as an instant result bug spray that can zap wasps, venomous Asian Hornets, African Killer Honey Bees, mosquitoes, poisonous Australian Jumping Jack ants, venomous spiders, non venomous and venomous ants and ant colonies, roaches and roach colonies right from mid flight or while crawling or nesting in their nests or in their hives; GOT CHA” provides to the those people who love to Barbeque, picnic, campout or stay on extended vacations a secure answer that grants the opportunity for people to stay longer at their picnic and campsites; remain inside their mobile homes, apartments or houses and encourage people to develop their sense for adventure and go out on excursions and follow insects back to their nests as all professional exterminators highly recommend feeling safe to use my GOOD GOD! “GOT CHA!” and wipe out the entire nest in less, with than a few sprays.
